(19) United States
(12) Patent Application Publication
(10) Pub. No.: US 2025/0353691 A1
(43) Pub. Date: Nov. 20, 2025

(54) BATTERY BREAKING SYSTEM WITH HOODED COLLECTOR

(71) Applicant: ACE GREEN RECYCLING INC., Houston, TX (US)

(72) Inventors: Avijit Gautam, Noida (IN); Mayankkumar Mohanbhai Patel, Salaiya (IN)

(73) Assignee: ACE GREEN RECYCLING INC., Houston, TX (US)

(21) Appl. No.: 18/666,042

(22) Filed: May 16, 2024

(51) Int. Cl. B65G 53/44; B65G 45/10; B65G 45/18; B65G 49/00; B65G 53/24; H01M 10/54

(52) U.S. Cl. CPC B65G 53/44; B65G 45/105; B65G 45/18; B65G 49/00; B65G 53/24; H01M 10/54; B65G 2201/042

(57) ABSTRACT

Disclosed are solutions for mitigating loss of black mass in the form of fine powder produced from breaking lithium-ion batteries (LIBs) during conveyance from one point in a process (e.g., the battery breaker) to a subsequent point in the process (e.g., a separator system) by means of a conveyance such as, for example, a conveyor belt system. Implementations of such a mitigation system, broadly referred to herein as a “hooded collector,” may comprise several different components including a hood-structure that fully encompasses the conveyance, a brush structure for disengaging the fine powder from the surface of the conveyance, a collector element for collecting some or all of the fine powder that might otherwise be lost, a negative-pressure airflow and filter for preventing loss at loss-possible openings, and/or a variety of other components.

### BACKGROUND

Recycling various components from spent lithium-ion batteries (LIBs) begins with breaking the LIBs and grinding them down into a fine powder to facilitate recovery of the component materials. This fine powder may then be conveyed from the breaker to a separator via a conveyor belt system. However, some of this fine powder may be lost during transport in the form of finer particles that become airborne dust, as well as a residue that adheres to the inverted surface of the conveyor belt and that falls away from the inverted portions of the belt. This loss of fine powder can be as much as 1.2% (i.e., 12 kg per metric ton) of the resultant fine powder produced by the breaker, which poses both a financial loss as well as health and environmental risks. Accordingly, there is a need for preventing loss of this fine powder during conveyance from the breaker to its next destination or processing step.

### SUMMARY

Disclosed herein are various implementations directed to systems and methods for mitigating loss of black mass in the form of fine powder produced from breaking lithium-ion batteries (LIBs) during conveyance from one point in a process (e.g., the battery breaker) to a subsequent point in the process (e.g., a separator system) by means of a conveyance such as, for example, a conveyor belt system. Implementations of such a mitigation system, broadly referred to herein as a “hooded collector,” may comprise several different components including a hood-structure that fully encompasses the conveyance (generally referred to herein simply as “a conveyance,” “the conveyance,” or “conveyances”), a brush structure for disengaging the fine powder from the surface of the conveyance, a collector element for collecting some or all of the fine powder that might otherwise be lost, a negative-pressure airflow and filter for preventing loss at loss-possible openings, and/or a variety of other components.

More specifically, various implementations disclosed herein are directed to a fine powder conveyance system comprising: a receiving unit for receiving fine powder produced by a battery breaker; a conveyance unit for receiving the fine powder from the battery breaker and conveying the fine powder to the receiving unit; and a hooded collector fully encompassing the conveyance unit and operating to reduce an amount of fine powder lost during conveyance by the conveyance unit. Several such implementations may also further comprise one or more of the following: a first brushing unit for removing fine powder adhering to the conveyance unit and directing said fine powder into the receiving unit; a second brushing unit for removing residual fine powder adhering to the conveyance unit that was not successfully removed by the first brushing unit; a negative-air-pressure system for at least partially facilitating receipt of the fine powder by the receiving unit; a negative-air-pressure system for at least partially preventing fine powder from escaping the interior of the hooded collector; at least one vibration-inducing motor for inducing vibration into the hooded collector to decrease the amount of residual fine powder adhering to interior surfaces of said hooded collector; at least one vibration-inducing motor for inducing vibration into the hooded collector to facilitate downward movement of the residual fine powder; a supplemental receiver for receiving fine powder that has become residual fine powder and at least partially reconveying this residual fine powder to the receiving unit via the conveyance system; a supplemental receiver for receiving fine powder that has become residual fine powder and at least partially reconveying this residual fine powder to the receiving unit via a secondary conveyance system; a cooling system to reduce the temperature within the interior of the hooded collector; and/or a control system for monitoring at least one operating condition of the system and automatically changing at least one operating parameter of the system when a threshold for the at least one operating condition is exceeded. Certain such implementations may also comprise one or more of the following features: wherein the at least one operating condition is the temperature within the interior of the hooded collector; wherein the fine powder is deposited onto a surface of the conveyance unit for conveyance, and wherein the fine powder is subsequently transferred from the conveyance unit to the receiving unit by inverting said surface; wherein the hooded collector comprises an interior surface to which fine powder cannot easily adhere; and wherein the hooded collector comprises an interior surface which when inclined facilitates downward movement of fine powder that has become residual fine powder.

Furthermore, various implementations disclosed herein are also directed to a fine powder conveyance system comprising: a receiving unit for receiving fine powder; a conveyance unit for conveying the fine powder to the receiving unit; a supplemental receiver for collection of fine powder that has become residual fine powder; and a hooded collector fully encompassing the conveyance unit, the hooded collector comprising an inclined lower interior surface upon which residual fine powder may settle and slide downward into the supplemental receiver. Several such implementations may also comprise at least one brushing unit for removing fine powder adhering to the conveyance unit and directing said fine powder into the receiving unit. Certain such implementations may also comprise one or more of the following features: wherein the conveyance unit receives the fine powder via a gravity-deposit onto a surface of said conveyance unit; and/or wherein the conveyance unit transfers the fine powder to the receiving unit by inverting the surface of said conveyance unit.

Additionally, various implementations disclosed herein are also directed to a an apparatus for production and conveyance of black mass in the form of fine powder from broken lithium-ion batteries, the apparatus comprising: a battery breaker for producing fine powder; a receiving unit for receiving the fine powder; a conveyance unit for conveying the fine powder to the receiving unit; a brushing unit to facilitate removal of the fine powder from the conveyance unit; and a hooded collector fully encompassing the conveyance unit and operating to collect fine powder that has become residual fine powder.

This summary is provided to introduce a selection of concepts in a simplified form that are further described below in the detailed description. This summary is not intended to identify key features or essential features of the claimed subject matter, nor is it intended to be used to limit the scope of the claimed subject matter, nor is it an admission that any of the information provided herein is prior art to the implementations described herein.

### BRIEF DESCRIPTION OF THE DRAWINGS

The foregoing summary and the following detailed description of illustrative implementations are better understood when read in conjunction with the appended drawings. For the purpose of illustrating the implementations, there is shown in the drawings example constructions of the implementations; however, the implementations are not limited to the specific methods and instrumentalities disclosed. In the drawings:

FIG. 1 is an illustration providing a partial cut-away side view of a fine powder conveyance system (FPCS) comprising a battery breaker, a conveyance unit, a receiving unit, a brushing unit, and a hooded collector, said FPCS being representative of various implementations disclosed herein;

FIG. 2 is an illustration providing a partial cut-away side view of the FPCS of FIG. 1 with a magnified focus of the far upper left portion of the FPCS showing airborne fine powder dust being confined within the interior of the hooded collector representative of various implementations disclosed herein;

FIG. 3 is an illustration providing a partial cut-away side view of the FPCS of FIG. 1 with a magnified focus of the upper right portion of the FPCS where the fine powder exits the battery breaker and is deposited onto the surface of the conveyance unit representative of various implementations disclosed herein;

FIG. 4 is an illustration providing a partial cut-away side view of the FPCS of FIG. 1 with a magnified focus of the upper left portion of the FPCS, representative of various implementations disclosed herein, wherein the fine powder is deposited by the conveyance unit into the receiving unit as the surface of the belt becomes inverted;

FIG. 5 is an illustration providing a partial cut-away side view of the FPCS of FIG. 1 with a magnified focus of the lower right portion of the FPCS, representative of various implementations disclosed herein, wherein fine powder fall-off and/or fine powder still adhering to the surface of the conveyance unit are collected by a supplemental receiver and redirected back to the receiving unit;

FIG. 6 is a process flow diagram illustrating an exemplary approach for automated operation of the of the FPCS of FIGS. 1-5 in a manner representative of the various implementations disclosed herein; and

FIG. 7 is a block diagram of an example computing environment that may be used in conjunction with any of the various implementations and aspects herein disclosed.

### DETAILED DESCRIPTION

An understanding of various concepts is helpful toward a broader and more complete understanding of the various implementations disclosed herein, and skilled artisans will readily appreciate the implications these various concepts have on the breadth and depth of the various implementations herein disclosed. While the several and various implementations disclosed herein may be described as specifically pertaining to or directed to use in recycling of lithium-ion batteries (LIBs), such implementations may be equally applied to the recovery of other metals and/or other metal sources. Accordingly, nothing herein is intended to limit the various implementations solely to LIB recycling but, instead, the various implementations disclosed herein may be applied to a variety of different processes and operations, and thus the disclosures made herein should be read as broadly as possible as applied to a variety of different metals and other substances being extracted or recovered from a variety of potentially different sources.

Furthermore, certain terms used herein may also be used interchangeably with other terms used herein and such terms should be given the broadest interpretation possible unless explicitly noted otherwise. For example, to the extent used herein, the terms electrolysis, electrowinning, and electrorefining should be treated as interchangeable terms such that where one term is used the other terms are also implied, and thus any use of the term electrolysis should be understood to also include electrowinning and electrorefining except where explicitly differentiated. Similarly, terms such as “electrolytic processes” (and variations thereof) and other such categorical terms, for example, should be interpreted to include and encompass electrolysis, electrowinning, and electrorefining, each individually and collectively without any undue limitation.

Additionally, as will be readily appreciated and well-understood by skilled artisans, substances that might typically be represented by their chemical compositions using subscripted numbers—such as gaseous oxygen (O2), water (H2O), and so forth—may instead be represented herein with regular numbers in lieu of subscripted numbers (e.g., as O2 for gaseous oxygen, H2O for water, and so forth) as being the same and equivalent substance as if subscripted numbers were utilized, and no distinction should be made as to the use of regular numbers versus the use of subscripted numbers anywhere herein.

Moreover, to the extent used herein (if any), and unless explicitly indicated otherwise, the term “near-pure” shall mean a purity comparable to within 90% of the average purity obtainable by traditional processes. Likewise, the term “pure” shall mean a purity that is equal to or exceeds the typical purity level obtainable by traditional processes, and the term “perfect purity” shall mean a purity that is 99.000% comprised of the target material without regard to anticipated localized variation (such as natural surface oxidation or hydroxidation, for example). Accordingly, for all implementations disclosed herein for obtaining “near-pure” substances (such as metals, for example), such disclosures should be deemed to also disclose alternative implementations for obtaining “pure” and “perfectly pure” substances as well. Also as used herein, the term “recovery” and other equivalent terms (e.g., purification, derivation, etc.) shall refer to the obtaining of a purer form of a target substance (e.g., an elemental form of a metal such as lead, etc.) from a less pure form of said substance (e.g., deriving elemental metals from metal oxides) or from other sources of the target substance.

### Battery Breaking

As briefly described earlier herein, reclaiming the various components from spent lithium-ion batteries (LIBs) begins with breaking the batteries and grinding down to a fine powder for recovery of component materials. This fine powder—a raw and unprocessed form of LIB “black mass” (as this term will be well-understood and readily-appreciated by skilled artisans)—may then be conveyed from the breaker to a separator via a conveyor belt system. However, some of this fine powder may be lost during transport in the form of relatively finer particles that become airborne dust, as well as a residue that adheres to the surface of the conveyor belt, even when in an inverted orientation and/or falling away from the inverted portions of the belt during operation. This loss of fine powder can be as much as 1.2% (i.e., 12 kg per metric ton) of the resultant fine powder produced by the breaker, which poses both a financial loss as well as health and environmental risks. Accordingly, there is a need for preventing loss of this fine powder during conveyance from the breaker to its next destination or processing step.

Conveyance Unit with Hooded Collector

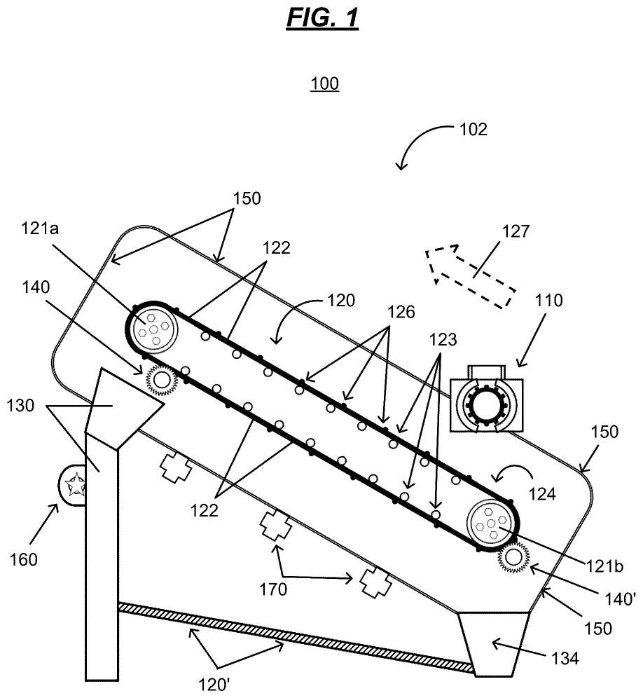

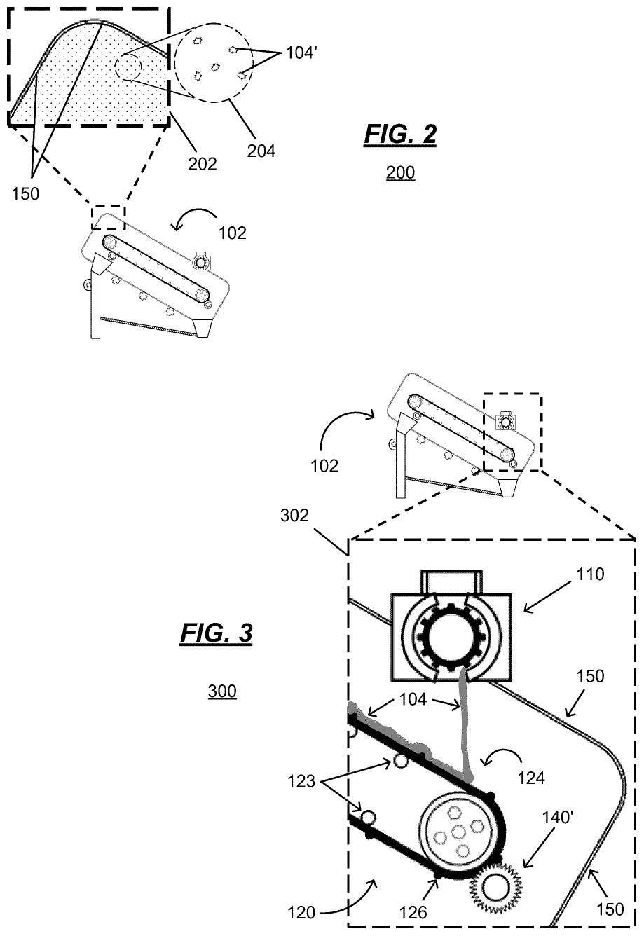

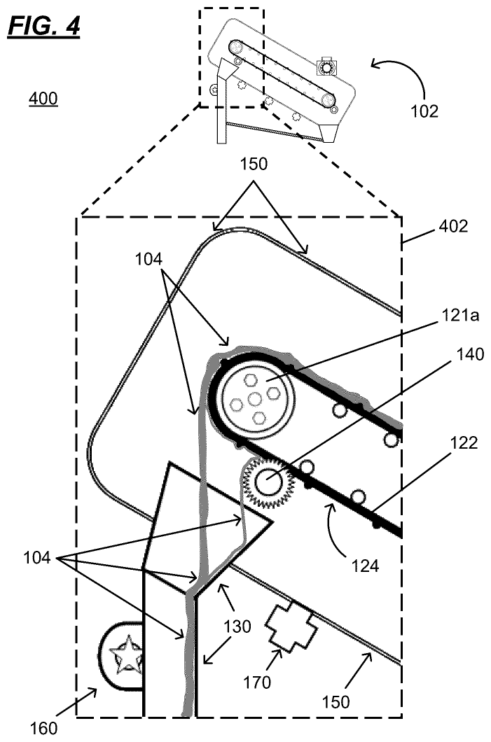

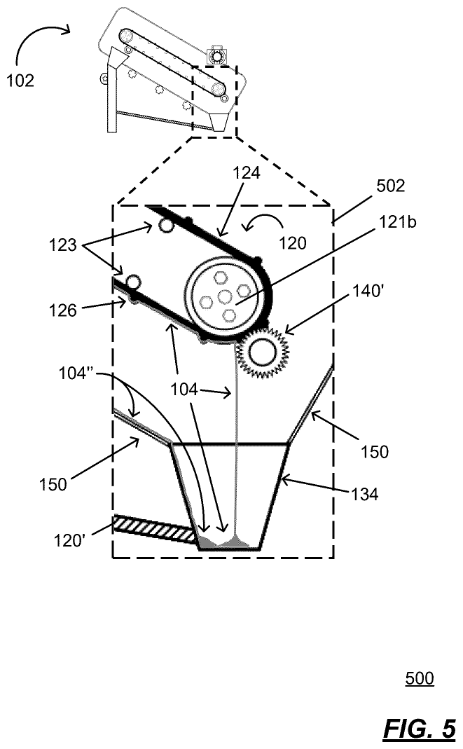

FIG. 1 is an illustration providing a partial cut-away side view 100 of a fine powder conveyance system (FPCS) 102 comprising a battery breaker 110, a conveyance unit 120, a receiving unit 130, a brushing unit 140, and a hooded collector 150, said FPCS 102 being representative of various implementations disclosed herein. FIG. 2 is an illustration providing a partial cut-away side view 200 of the FPCS 102 of FIG. 1 with a magnified focus 202 (indicated with dashed lines) of the far upper left portion of the FPCS 102 showing airborne fine powder dust 104′ being confined within the interior of the hooded collector 150 representative of various implementations disclosed herein. FIG. 3 is an illustration providing a partial cut-away side view 300 of the FPCS 102 of FIG. 1 with a magnified focus 302 (indicated with dashed lines) of the upper right portion of the FPCS 102 where the fine powder 104 exits the battery breaker 110 and is deposited onto the surface 124 of the conveyance unit 120 representative of various implementations disclosed herein. FIG. 4 is an illustration providing a partial cut-away side view 400 of the FPCS 102 of FIG. 1 with a magnified focus 402 (indicated with dashed lines) of the upper left portion of the FPCS 102, representative of various implementations disclosed herein, wherein the fine powder 104 is deposited by the conveyance unit 120 into the receiving unit 130 as the surface 124 of the belt 122 becomes inverted. FIG. 5 is an illustration providing a partial cut-away side view 500 of the FPCS 102 of FIG. 1 with a magnified focus 502 (indicated with dashed lines) of the lower right portion of the FPCS 102, representative of various implementations disclosed herein, wherein fine powder fall-off 104″ and/or fine powder 104 still adhering to the surface 124 of the conveyance unit 120 are collected by a supplemental receiver 134 and redirected back to the receiving unit 130.

As variously illustrated in FIGS. 1-5, fine powder 104 (not shown in FIG. 1) may exit the battery breaker 110 of the FPCS 102 and be gravity-deposited onto the surface 124 (or “bed”) of the conveyance unit 120 (or “conveyor”), for example, a conveyor-belt-type conveyance system comprising a belt 122 that may be extended between two drums 121a and 121b and supported there-between by a series of rollers 123. The surface 124 of the belt 122, upon which the fine powder 104 rests while being conveyed, may be a flat surface or, as shown, an angled surface upon which the fine powder 104 may be deposited and transported. The surface 124 may further comprise cleats 126 that facilitate the transport of the powder against an incline if the surface 124 is angled or inclined, for example. These cleats 126 may comprise a plurality of attachments fastened to the surface 124 to act as a pusher, support, check, trip, or other such features or combination of features that help transport the fine powder 104 in the intended direction of travel (indicated by the dashed-line arrow 127). The fine powder 104 is then deposited into a receiving unit 130 where the surface 124 of the belt 122 becomes inverted as it rotates around the first drum 121a.

A brushing unit 140 (or belt scraper or other such component) may be positioned to contact the moving conveyor belt 122 and facilitate removal of any fine powder 104 adhering to the conveyor belt 122 and help direct this fine powder 104 into the receiving unit 130. One or more additional brushing units (e.g., high-pressure brushing unit 140′) may also be utilized to help remove additional fine powder 104 adhering to the conveyor belt 122 for direct (not shown) or indirect reconveyance to the receiving unit 130. The FPCS 102 may further comprise a negative-air-pressure system (NAPS) 160 to facilitate the depositing of fine powder 104 into the receiving unit 130 and/or help prevent inadvertent escape of the fine powder dust 104′ (explicitly shown only in FIG. 2 but implied for the other drawings) from the interior confines of the hooded collector 150 by effectively creating a relatively low-level but sufficient flow of air from outside the hooded collector 150 into the interior of the hooded collector 150 through any holes, gaps, seams, or other openings of the hooded collector 150.

The FPCS 102 may further comprise a hooded collector 150 which may fully encompass the conveyance unit 120 and the fine powder 104 (including airborne dust 104′ thereof) received from the battery breaker 110 and being conveyed thereby to the receiving unit 130. In effect, the hooded collector 150 substantially maintains within its interior any airborne fine powder dust 104′ while also catching any fine powder fall-off 104″ escaping from the surface 124 of the conveyance unit 120 and falling below the conveyance unit 120 (to include any settling fine powder dust 104′ that had been airborne). Fine powder dust 104′ and fine powder fall-off 104″ may be collectively referred to herein as “residual fine powder,” and residual fine powder may also include any fine powder that adheres to the surface 124 of the belt 122 of the conveyance unit 120 and is not successfully deposited into the receiving unit.

To facilitate this catching, the interior surfaces of the hooded collector may comprise a material to which the fine powder 104 cannot easily adhere and/or vibration-inducing motors 170 (shown mounted to the exterior of the hooded collector 150) in order to further facilitate settlement and movement of this otherwise lost fine powder 104 in a downward direction (when sufficiently angled or inclined) to a supplemental receiver 134 that, in turn, may re-deposit the collected fine powder back onto the surface 124 of the belt 122 of the conveyance unit 120 (not shown) and/or may re-deposit the collected fine powder 104 directly into the receiving unit 130 via a secondary conveyance system 120′ which may further comprise an augur, a vacuum tube (possibly operating in conjunction with the NAPS 160, for example), or other suitable material-moving subsystem.

Notably, when LIBs are broken in the battery breaker, the metallic lithium may become exposed to atmospheric moisture and result in chemical reactions that generate heat and possibly open flames that may damage motors, electrical wiring, and rubber coatings, and even more significant issues. While the heat generated by these chemical reactions may mostly accumulate above the breaker itself, this heat may also be conveyed by the fine powder 104 into the interior of the hooded collector and therein trapped. Therefore, for certain implementations disclosed herein the FPCS 102 may further comprise a cooling system for maintaining temperature control of the battery breaker 110 or other components (including the fine powder 104 produced by the battery breaker 110) and/or an automated feeding system (which may include a hopper) for controlled feeding of LIBs into the battery breaker. For example, the features of the cooling system and/or automated hopper system described by U.S. patent application Ser. No. 18/638,683 filed on Apr. 18, 2024 and titled “BATTERY BREAKER COMPRISING AUTOMATED FEEDING SYSTEM” (Attorney Docket No. AGR2402US1U)—the entirely of which is incorporated herein by reference—may be utilized, adapted, and/or extended for use with the FPCS 102. In particular, the cooling system may be extended to include circulating coolant within the interior of the hooded collector 150 and/or even within channels in the walls of the hooded collector 150 itself.

To further facilitate the collection conveyance of fine powder 104 from the breaker 110 to its next destination or processing step (e.g., the receiving unit 130), the FPCS 102 may further comprise a control system (not shown) for monitoring operating conditions of FPCS 102 and changing one or more operating parameters based on one or more of the operating conditions exceeding a threshold that may be defined by a user/operator of the FPCS 102. For example, the control system may monitor temperature of one or more components, throughput of the fine powder 104, resistance on movement of the belt 122, weight on the surface 124 of the conveyance unit 120, air pressure within the interior of the hooded collector 150, amount of material collected in the supplemental receiver 134, and so on and so forth. When a threshold corresponding to a monitored operating condition is then exceeded, the control system may change one or more operating parameters such as, for example, increasing or decreasing the speed of the breaker, the conveyor belt, or the secondary conveyor; varying the amount of negative air pressure; increasing the flow of coolant through the system; and/or any of several other operating parameters including those that precede battery breaking and/or those that are a subsequent part of or follow the collecting unit. For various implementations, this control system may comprise a computing environment such as the exemplary computing environment discussed in detail later herein.

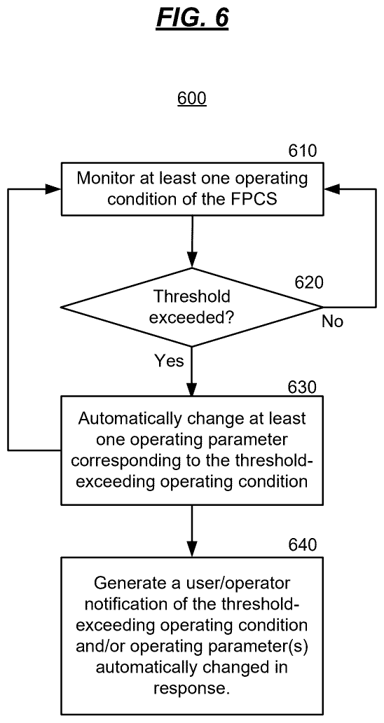

FIG. 6 is a process flow diagram 600 illustrating an exemplary approach for automated operation of the FPCS of FIGS. 1-5 in a manner representative of the various implementations disclosed herein. As shown in FIG. 6, at 610 the control system monitors at least one operating condition of the FPCS 102 to determine, at 620, whether a monitored operating condition exceeds a predetermined threshold (which may be set and changeable by the user/operator of the FPCS 102). If operating conditions do not exceed any thresholds, the control system returns to 610 to monitor the operating conditions of the FPCS 102. On the other hand, if a threshold is exceeded, then at 630 the control system may automatically change at least one operating parameter of the FPCS 102 directly or indirectly corresponding to the threshold-exceeding operating condition. The monitoring system may then return to 610 to further monitoring the operating conditions of the FPCS 102 and, at 640, generate a user/operator notification of the threshold-exceeding operating condition, the operating parameter(s) automatically changed in response to the detected threshold-exceeding operating condition, and/or provide other relevant data or recommendations relevant to the threshold-exceeding operating condition or general operation of the FPCS 102.

Accordingly, various implementations disclosed herein are directed to a fine powder conveyance system comprising: a receiving unit for receiving fine powder produced by a battery breaker; a conveyance unit for receiving the fine powder from the battery breaker and conveying the fine powder to the receiving unit; and a hooded collector fully encompassing the conveyance unit and operating to reduce an amount of fine powder lost during conveyance by the conveyance unit. Several such implementations may also further comprise one or more of the following: a first brushing unit for removing fine powder adhering to the conveyance unit and directing said fine powder into the receiving unit; a second brushing unit for removing residual fine powder adhering to the conveyance unit that was not successfully removed by the first brushing unit; a negative-air-pressure system for at least partially facilitating receipt of the fine powder by the receiving unit; a negative-air-pressure system for at least partially preventing fine powder from escaping the interior of the hooded collector; at least one vibration-inducing motor for inducing vibration into the hooded collector to decrease the amount of residual fine powder adhering to interior surfaces of said hooded collector; at least one vibration-inducing motor for inducing vibration into the hooded collector to facilitate downward movement of the residual fine powder; a supplemental receiver for receiving fine powder that has become residual fine powder and at least partially reconveying this residual fine powder to the receiving unit via the conveyance system; a supplemental receiver for receiving fine powder that has become residual fine powder and at least partially reconveying this residual fine powder to the receiving unit via a secondary conveyance system; a cooling system to reduce the temperature within the interior of the hooded collector; and/or a control system for monitoring at least one operating condition of the system and automatically changing at least one operating parameter of the system when a threshold for the at least one operating condition is exceeded. Certain such implementations may also comprise one or more of the following features: wherein the at least one operating condition is the temperature within the interior of the hooded collector; wherein the fine powder is deposited onto a surface of the conveyance unit for conveyance, and wherein the fine powder is subsequently transferred from the conveyance unit to the receiving unit by inverting said surface; wherein the hooded collector comprises an interior surface to which fine powder cannot easily adhere; and wherein the hooded collector comprises an interior surface which when inclined facilitates downward movement of fine powder that has become residual fine powder.

Furthermore, various implementations disclosed herein are also directed to a fine powder conveyance system comprising: a receiving unit for receiving fine powder; a conveyance unit for conveying the fine powder to the receiving unit; a supplemental receiver for collection of fine powder that has become residual fine powder; and a hooded collector fully encompassing the conveyance unit, the hooded collector comprising an inclined lower interior surface upon which residual fine powder may settle and slide downward into the supplemental receiver. Several such implementations may also comprise at least one brushing unit for removing fine powder adhering to the conveyance unit and directing said fine powder into the receiving unit. Certain such implementations may also comprise one or more of the following features: wherein the conveyance unit receives the fine powder via a gravity-deposit onto a surface of said conveyance unit; and/or wherein the conveyance unit transfers the fine powder to the receiving unit by inverting the surface of said conveyance unit.

Additionally, various implementations disclosed herein are also directed to a an apparatus for production and conveyance of black mass in the form of fine powder from broken lithium-ion batteries, the apparatus comprising: a battery breaker for producing fine powder; a receiving unit for receiving the fine powder; a conveyance unit for conveying the fine powder to the receiving unit; a brushing unit to facilitate removal of the fine powder from the conveyance unit; and a hooded collector fully encompassing the conveyance unit and operating to collect fine powder that has become residual fine powder.

### Example Computing Environment

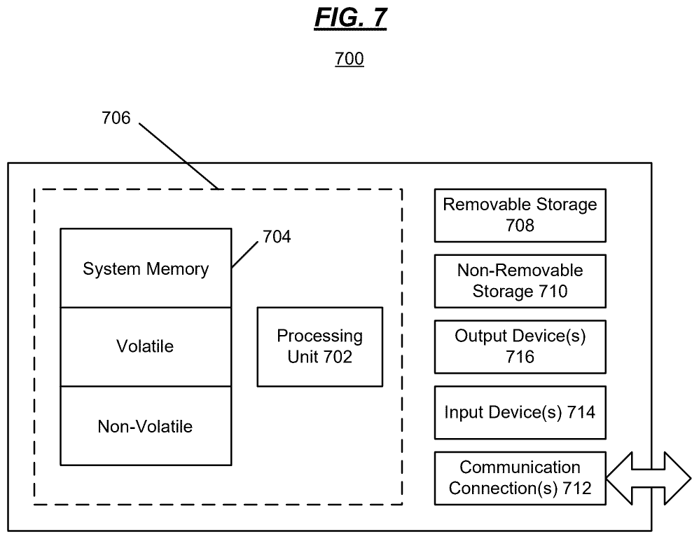

FIG. 7 is a block diagram of an example computing environment that may be used in conjunction with example implementations and aspects such as those disclosed and described with regard to the other figures presented herein and herewith. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, and so forth that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA), an analog-to-digital converter (ADC), or other programmable logic device, discrete gate or transistor logic, discrete hardware components, discrete data acquisition components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

With reference to FIG. 7, an example system for implementing aspects described herein includes a computing device, such as computing device 700. In a basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This basic configuration is illustrated in FIG. 7 by dashed line 706 and may be referred to collectively as the “compute” component.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710. Computing device 700 typically includes a variety of computer readable media. Computer readable media can be any available media that can be accessed by device 700 and may include both volatile and non-volatile media, as well as both removable and non-removable media.

Computer storage media include volatile and non-volatile media, as well as removable and non-removable media, implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store the information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, and so forth. Output device(s) 716 such as a display, speakers, printer, and so forth may also be included. All these devices are well-known in the art and need not be discussed at length herein. Computing device 700 may be one of a plurality of computing devices 700 inter-connected by a network. As may be appreciated, the network may be any appropriate network, each computing device 700 may be connected thereto by way of communication connection(s) 712 in any appropriate manner, and each computing device 700 may communicate with one or more of the other computing devices 700 in the network in any appropriate manner. For example, the network may be a wired or wireless network within an organization or home or the like, and may include a direct or indirect coupling to an external network such as the Internet or the like. Moreover, PCI, PCIe, and other bus protocols might be utilized for embedding the various implementations described herein into other computing systems.

### Interpretation of Disclosures Herein

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high-level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Certain implementations described herein may utilize a cloud operating environment that supports delivering computing, processing, storage, data management, applications, and other functionality as an abstract service rather than as a standalone product of computer hardware, software, etc. Services may be provided by virtual servers that may be implemented as one or more processes on one or more computing devices. In some implementations, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database, etc.) of a device that is actually providing the service (e.g., computing, storage). Users may access cloud services via, for example, a web browser, a thin client, a mobile application, or in other ways. To the extent any physical components of hardware and software are herein described, equivalent functionality provided via a cloud operating environment is also anticipated and disclosed.

Additionally, a controller service may reside in the cloud and may rely on a server or service to perform processing and may rely on a data store or database to store data. While a single server, a single service, a single data store, and a single database may be utilized, multiple instances of servers, services, data stores, and databases may instead reside in the cloud and may, therefore, be used by the controller service. Likewise, various devices may access the controller service in the cloud, and such devices may include (but are not limited to) a computer, a tablet, a laptop computer, a desktop monitor, a television, a personal digital assistant, and a mobile device (e.g., cellular phone, satellite phone, etc.). It is possible that different users at different locations using different devices may access the controller service through different networks or interfaces. In one example, the controller service may be accessed by a mobile device. In another example, portions of controller service may reside on a mobile device. Regardless, controller service may perform actions including, for example, presenting content on a secondary display, presenting an application (e.g., browser) on a secondary display, presenting a cursor on a secondary display, presenting controls on a secondary display, and/or generating a control event in response to an interaction on the mobile device or other service. In specific implementations, the controller service may perform portions of methods described herein.

### Anticipated Alternatives

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Moreover, it will be apparent to one skilled in the art that other implementations may be practiced apart from the specific details disclosed above.

The drawings described above and the written description of specific structures and functions below are not presented to limit the scope of what has been invented or the scope of the appended claims. Rather, the drawings and written description are provided to teach any person skilled in the art to make and use the inventions for which patent protection is sought. Those skilled in the art will appreciate that not all features of a commercial implementation of the inventions are described or shown for the sake of clarity and understanding. Skilled artisans will further appreciate that block diagrams herein can represent conceptual views of illustrative circuitry embodying the principles of the technology, and that any flow charts, state transition diagrams, pseudocode, and the like represent various processes which may be embodied in computer readable medium and so executed by a computer or processor, whether or not such computer or processor is explicitly shown. The functions of the various elements including functional blocks may be provided through the use of dedicated electronic hardware as well as electronic circuitry capable of executing computer program instructions in association with appropriate software. Persons of skill in this art will also appreciate that the development of an actual commercial implementation incorporating aspects of the inventions will require numerous implementation-specific decisions to achieve the developer's ultimate goal for the commercial implementation. Such implementation-specific decisions may include, and likely are not limited to, compliance with system-related, business-related, government-related, and other constraints, which may vary by specific implementation, location, and from time to time. While a developer's efforts might be complex and time-consuming in an absolute sense, such efforts would be, nevertheless, a routine undertaking for those of skill in this art having benefit of this disclosure.

It should be understood that the implementations disclosed and taught herein are susceptible to numerous and various modifications and alternative forms. Thus, the use of a singular term, such as, but not limited to, “a” and the like, is not intended as limiting of the number of items. Also, the use of relational terms, such as, but not limited to, “top,” “bottom,” “left,” “right,” “upper,” “lower,” “down,” “up,” “side,” and the like, are used in the written description for clarity in specific reference to the drawings and are not intended to limit the scope of the invention or the appended claims. For particular implementations described with reference to block diagrams and/or operational illustrations of methods, it should be understood that each block of the block diagrams and/or operational illustrations, and combinations of blocks in the block diagrams and/or operational illustrations, may be implemented by analog and/or digital hardware, and/or computer program instructions. Computer program instructions for use with or by the implementations disclosed herein may be written in an object-oriented programming language, conventional procedural programming language, or lower-level code, such as assembly language and/or microcode. The program may be executed entirely on a single processor and/or across multiple processors, as a stand-alone software package or as part of another software package. Such computer program instructions may be provided to a processor of a general-purpose computer, special-purpose computer, ASIC, and/or other programmable data processing system. The executed instructions may also create structures and functions for implementing the actions specified in the mentioned block diagrams and/or operational illustrations. In some alternate implementations, the functions/actions/structures noted in the drawings may occur out of the order noted in the block diagrams and/or operational illustrations. For example, two operations shown as occurring in succession, in fact, may be executed substantially concurrently or the operations may be executed in the reverse order, depending on the functionality/acts/structure involved.

The term “computer-readable instructions” as used above refers to any instructions that may be performed by the processor and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device. Volatile media may include dynamic memory, such as main memory. Transmission media may include coaxial cables, copper wire, and fiber optics, including wires of the bus. Transmission media may also take the form of acoustic or light waves, such as those generated during radio frequency (RF) and infrared (IR) data communications. Common forms of computer-readable media may include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

In the foregoing description, for purposes of explanation and non-limitation, specific details are set forth—such as particular nodes, functional entities, techniques, protocols, standards, etc.—in order to provide an understanding of the described technology. In other instances, detailed descriptions of well-known methods, devices, techniques, etc. are omitted so as not to obscure the description with unnecessary detail. All statements reciting principles, aspects, embodiments, and implementations, as well as specific examples, are intended to encompass both structural and functional equivalents, and such equivalents include both currently known equivalents as well as equivalents developed in the future, i.e., any elements developed that perform the same function, regardless of structure. While the disclosed implementations have been described with reference to one or more particular implementations, those skilled in the art will recognize that many changes may be made thereto. Therefore, each of the foregoing implementations and obvious variations thereof is contemplated as falling within the spirit and scope of the disclosed implementations, which are set forth in the claims presented below.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

What is claimed:

1. A fine powder conveyance system comprising:
a receiving unit for receiving fine powder produced by a battery breaker;
a conveyance unit for receiving the fine powder from the battery breaker and conveying the fine powder to the receiving unit; and
a hooded collector fully encompassing the conveyance unit and operating to reduce an amount of fine powder lost during conveyance by the conveyance unit.

2. The system of claim 1, further comprising a first brushing unit for removing fine powder adhering to the conveyance unit and directing said fine powder into the receiving unit.

3. The system of claim 2, further comprising a second brushing unit for removing residual fine powder adhering to the conveyance unit that was not successfully removed by the first brushing unit.

4. The system of claim 1, wherein the fine powder is deposited onto a surface of the conveyance unit for conveyance, and wherein the fine powder is subsequently transferred from the conveyance unit to the receiving unit by inverting said surface.

5. The system of claim 1, further comprising a negative-air-pressure system for at least partially facilitating receipt of the fine powder by the receiving unit.

6. The system of claim 1, further comprising a negative-air-pressure system for at least partially preventing fine powder from escaping the interior of the hooded collector.

7. The system of claim 1, wherein the hooded collector comprises an interior surface to which fine powder cannot easily adhere.

8. The system of claim 7, wherein the hooded collector comprises an interior surface which when inclined facilitates downward movement of fine powder that has become residual fine powder.

9. The system of claim 8, further comprising at least one vibration-inducing motor for inducing vibration into the hooded collector to decrease the amount of residual fine powder adhering to interior surfaces of said hooded collector.

10. The system of claim 8, further comprising at least one vibration-inducing motor for inducing vibration into the hooded collector to facilitate downward movement of the residual fine powder.

11. The system of claim 1, further comprising a supplemental receiver for receiving fine powder that has become residual fine powder and at least partially reconveying this residual fine powder to the receiving unit via the conveyance system.

12. The system of claim 1, further comprising a supplemental receiver for receiving fine powder that has become residual fine powder and at least partially reconveying this residual fine powder to the receiving unit via a secondary conveyance system.

13. The system of claim 1, further comprising a cooling system to reduce the temperature within the interior of the hooded collector.

14. The system of claim 1, further comprising a control system for monitoring at least one operating condition of the system and automatically changing at least one operating parameter of the system when a threshold for the at least one operating condition is exceeded.

15. The system of claim 14 wherein the at least one operating condition is the temperature within the interior of the hooded collector.

16. A fine powder conveyance system comprising:
a receiving unit for receiving fine powder;
a conveyance unit for conveying the fine powder to the receiving unit;
a supplemental receiver for collection of fine powder that has become residual fine powder; and
a hooded collector fully encompassing the conveyance unit, the hooded collector comprising an inclined lower interior surface upon which residual fine powder may settle and slide downward into the supplemental receiver.

17. The system of claim 16, further comprising at least one brushing unit for removing fine powder adhering to the conveyance unit and directing said fine powder into the receiving unit.

18. The system of claim 17, wherein the conveyance unit receives the fine powder via a gravity-deposit onto a surface of said conveyance unit.

19. The system of claim 18, wherein the conveyance unit transfers the fine powder to the receiving unit by inverting the surface of said conveyance unit.

20. An apparatus for production and conveyance of black mass in the form of fine powder from broken lithium-ion batteries, the apparatus comprising:
a battery breaker for producing fine powder;
a receiving unit for receiving the fine powder;
a conveyance unit for conveying the fine powder to the receiving unit;
a brushing unit to facilitate removal of the fine powder from the conveyance unit; and
a hooded collector fully encompassing the conveyance unit and operating to collect fine powder that has become residual fine powder.
